(19) United States
(12) Patent Application Publication
(10) Pub. No.: US 2014/0108109 A1
(43) Pub. Date: Apr. 17, 2014

(54) Method of Advertising Household Items

(71) Applicant: Louis L. Glickfield, Rockville, MD (US)

(72) Inventor: Louis L. Glickfield, Rockville, MD (US)

(21) Appl. No.: 13/838,027

(22) Filed: Mar. 15, 2013

Related U.S. Application Data
(63) Continuation-in-part of application No. 13/276,296, filed on Oct. 18, 2011, now abandoned.

(51) Int. Cl. G06Q 30/02

(52) U.S. Cl. CPC G06Q 30/0241
USPC 705/14.4

(57) ABSTRACT

A method for advertising household items by placing a graphic display of the household item in the vicinity of the household item at a retail location. The household item in the household display is shown in the environment in which it is intended to be utilized. The ability to view the household item in the particular environment for which it is design enhances the consumer experience and facilitates a confident decision by the purchasers. The method of advertising household items also entails preparing the graphic display, printing the graphic display, framing the graphic display, and placing the graphic display in the vicinity of the household item.

### CROSS-REFERENCE TO RELATED APPLICATIONS

This application is a continuation-in-part of co-pending U.S. patent application Ser. No. 13/276,296 entitled “Method of Advertising Household Items,” filed with the U.S. Patent and Trademark Office on Oct. 18, 2011 by the inventor herein, the specification of which is incorporated herein by reference in its entirety.

### BACKGROUND OF THE INVENTION

1. Field of the Invention

This invention relates to a method for advertising household items at retail locations.

2. Description of the Background

Household items are currently advertised in catalogues, printed magazines, and other media in which a consumer can view the item in various settings. Catalogues may be found at retail locations near the checkout counter and in some instances near the household item. Newspaper and magazine ads may allow a consumer to visualize the item in a particular setting. Billboards are placed outside buildings and on the street to advertise stores and other services to the public.

Likewise, stores that sell furniture, appliances, and other household items often will place those items on display so that a consumer that is browsing through the store can easily view the full piece of furniture or appliance and interact with it directly. However, it can be quite a challenge for the retailer to grab the consumer's interest to have them interact with, and then to ultimately build sufficient interest in, the item to ultimately purchase that item. For instance, while typical furniture stores may provide floor displays of a furniture item, it can be quite difficult for a consumer to envision that furniture item in an actual space in which they would intend to use it, such as a room within a residential or office building. More particularly, the typically wide expanse of a furniture showroom, lacking defined, segmented rooms or ceilings, can make it quite difficult for the browsing shopper to envision the furniture item within such an enclosed space as a room in a residential or office building. If the browsing shopper is not able to quickly associate the furniture item with a mental picture of that furniture item within a space in which they would likely use the item, that browsing shopper is likely to pass the item by, and the retailer loses the opportunity to have possibly sold that furniture item.

Thus, there remains a need in the art for advertising methods that allow the consumer to readily envision a furniture or other item in the specific setting in which it will likely be used, while allowing the user to simultaneously view the actual furniture or other item near the household item the individual is about to purchase and to interact with that item.

### SUMMARY OF THE INVENTION

A method for advertising household items is described in which a graphic display showing the household item, as it would look in a particular room setting or natural environment for such household item, is placed in the vicinity of a household item. A method of advertising a household item is also provided. An initial step of the method consists of preparing a graphic display image of a household item in its intended environment. Another step consists of printing the graphic display. Yet another step of the method consists of placing the graphic display in the vicinity of the household item.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is a graphic display of the method in accordance with one embodiment of the present invention.

FIG. 2A is a picture of the graphic display in accordance with one embodiment of the present invention showing a sofa in a room setting, where the graphic display is placed next to the sofa on the sales floor.

FIG. 2B is a close up picture of the graphic display shown in FIG. 2A in accordance with one embodiment of the present invention showing a sofa in a room setting, where the graphic display is placed next to the sofa on the sales floor.

FIG. 3A is a picture of the graphic display in accordance with one embodiment of the present invention showing a sofa in a room setting, where the graphic display is placed next to the sofa on the sales floor.

FIG. 3B is a close up picture of the graphic display shown in FIG. 3A in accordance with one embodiment of the present invention showing a sofa in a room setting, where the graphic display is placed next to the sofa on the sales floor.

FIG. 4A is a picture of the graphic display in accordance with one embodiment of the present invention showing a dining room set in a room setting, where the graphic display is placed on the dining room set on the sales floor.

FIG. 4B is a close up picture of the graphic display shown in FIG. 4A in accordance with one embodiment of the present invention showing a dining room set in a room setting, where the graphic display is placed on the dining room set on the sales floor.

FIGS. 5A-5C are pictures of the graphic display in accordance with an embodiment of the invention providing a floating appearance to the graphic display.

FIG. 6 is a flow diagram of a method in accordance with an embodiment of the present invention.

FIG. 7 is a schematic view of a computer system according to an embodiment of the invention.

FIG. 8 is a flow diagram of a method of accessorizing a room in accordance with a further embodiment of the present invention by displaying the household item in a computer screen.

### DETAILED DESCRIPTION

The invention summarized above may be better understood by referring to the following description, the accompanying drawings, and the claims listed below. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

It is an object of an embodiment of the invention to provide a method for advertising at a retail location, such as a furniture store, a carpeting store, a flooring store, a light fixture retail establishment, an appliance store, and any other type of retail store that sells household items to consumers. The method allows a consumer to have confidence in the purchasing decision. The heightened confidence in the purchase helps the consumer make the most appropriate decision for his or her situation. Such confidence increases the likelihood that the consumer will finalize a sale. Furthermore, providing the consumer with the right item for his or her household reduces the number of returns of merchandise. The ability to make an informed decision about the purchase enhances the customer's experience at the store and, thus, it is likely that the customer will return for future purchases.

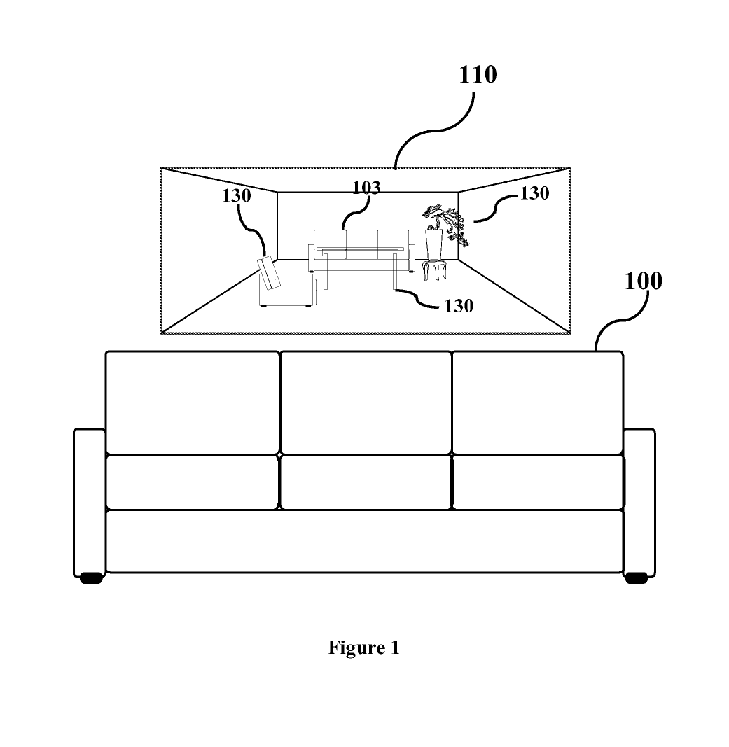

With regard to a particular aspect of the invention, a method of advertising household items is provided. The household item may be a chair, table, sofa, dining room set, bedroom furniture, or any other type of furniture. The household item may also include flooring, whether wood flooring or carpeting. The household item may further include appliances, such as refrigerators, washer machines, dryer machines, televisions, or any other type of appliance. The household item may further include lighting fixtures, kitchen fixtures, bathroom fixtures, or other such items placed in the home. With particular reference to FIG. 1, the method may comprise placing a two-dimensional graphic display 110 of a household item 100 next to the household item 100 at a retail location. The graphic display 110 shows a graphical representation 103 of the household item 100 in an intended use setting—i.e., a representation of an actual enclosed room within a residential or commercial building in which the household item 100 would typically be used. The graphic display may be printed in any size. For example, the graphic display 110 may be a 30 in by 40 in living room display; it may be a 30 in by 60 in sectional display; or it may also be a 24 in by 36 in bedroom or dining room display. It is contemplated that the graphic display may be of any size that is larger than a picture in a catalogue.

With further reference to FIG. 1, graphic display 110 of household item 100 is placed near, such as immediately adjacent to, the household item 100. The graphic display 110 shows a graphical representation 103 of the household item 100 as it would look in its environment at a home or office. By way of example, as shown in FIG. 1, the household item 100 may be a piece of furniture, an appliance, or another household item that would typically be placed in a particular place and for which the aesthetic properties of the product are important to the consumer. As shown in FIG. 1, the graphic display 110 of a sofa, as it would look in a given room, is placed behind and more preferably above the sofa 100. The graphic display 110 of the sofa includes an enclosed room (typically showing at least two walls, a floor and a ceiling to represent an actual room in a residential or office building) in which the sofa is placed, along with other accessories 130 customarily included in such a room. The accessories 130 may include a table, a plant, paintings, other furniture next to the sofa, and any other items that are appropriate for the type of household item being sold. More particularly, accessories 130 presented in graphic display 110 are preferably thematically associated with the intended use setting depicted in graphic display 110. As shown in FIG. 1, the intended use setting may comprise a living room, and accessories 130 are thus all thematically associated with a living room setting, and comprise a chair, coffee table, plant, and the like. Alternatively, the furniture item 100 being advertised for sale at the retail location could instead comprise a youth bed, with the intended setting shown in two-dimensional graphic display 110 comprising a youth bedroom. In this case, accessories 130 could comprise, by way of non-limiting example, a children's toy box, a work desk, a computer, etc. In each case, the graphic display 110 allows the consumer to visualize how the household item 100 will look in a particular setting, such as a dining room, living room, or other desired setting.

In a particularly preferred embodiment, the view of intended use setting depicted on graphic display 110 shows an enclosed space, such as a complete room having walls, a floor, and a ceiling. The typical retail showroom environment will often include displays of furniture or other items that, while arranged with other items in an aesthetically pleasing presentation, nonetheless are placed in the large expanse of a showroom warehouse, thus often lacking the walls and ceiling of an enclosed room. While the full size furniture item being advertised for sale through display in the showroom would be intended for ultimate use in such an enclosed space, the browsing customer can find it difficult to immediately visualize the use of the furniture item within such an actual enclosed room in a residence, office building or the like. Thus, so as to enable the browsing customer to immediately visualize the use of the furniture item within an enclosed room, graphic display 110 shows what at least appears to be an enclosed room, particularly by providing a perspective view that shows at least a floor, a ceiling, and a plurality of walls.

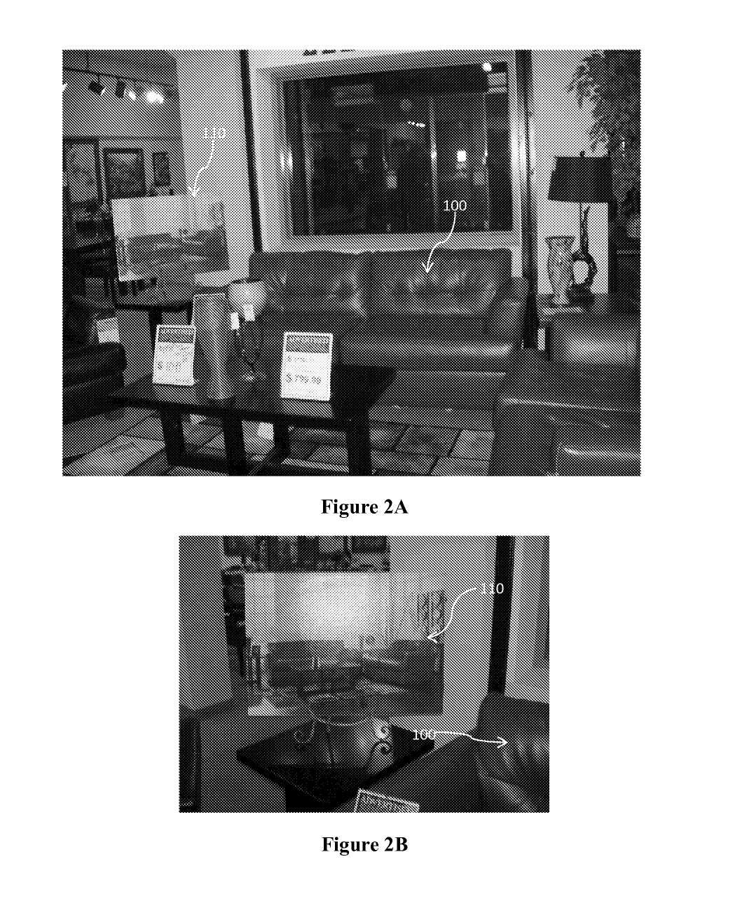

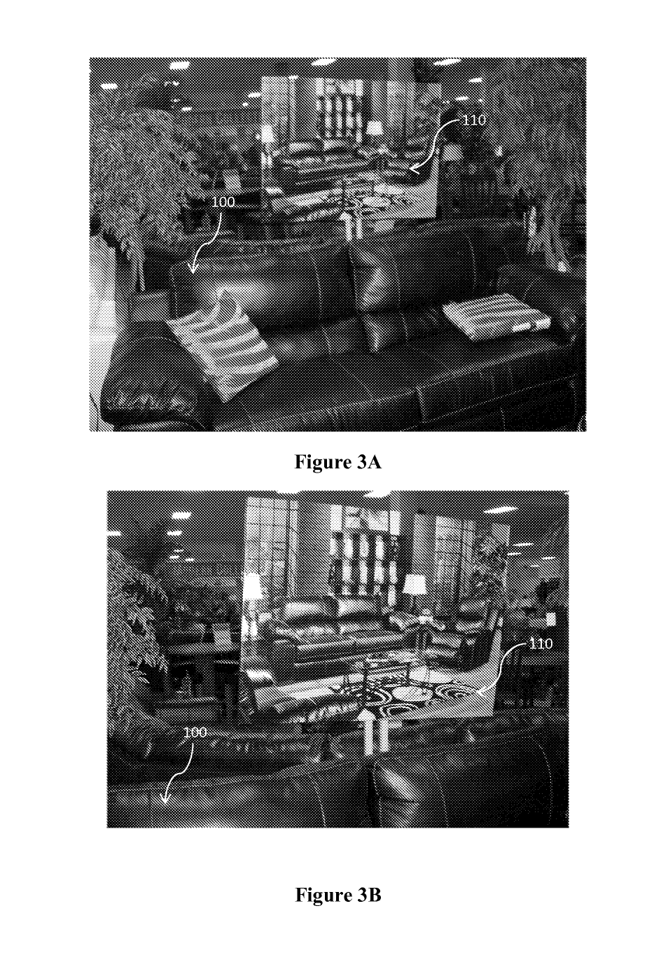

Moreover, by positioning such graphic display 110 immediately adjacent the full size furniture item 100 being advertised for sale, the customer is presented that intended use, enclosed room view simultaneously with their first view of the actual furniture item 100, thus reducing the risk of the customer dismissing the possibility of purchasing the furniture item merely because of a difficulty in envisioning the furniture item 100 in a space where they would ultimately use it. FIGS. 2A-4B show various applications of the method in which graphic display 110, showing placement of a furniture item 100 in an intended use setting, is positioned in an advertising display with the full size furniture item 100 being advertised for sale.

Graphic display 110 may comprise a picture or a drawing of the household item 100 in the environment in which the household item 100 would typically be utilized. In some embodiments of the present invention, the graphic display 110 is a picture that can be taken with an analog camera, a digital camera, or any other device that allows a person to capture an image of the household item 100 in its natural or designated environment. In an alternative embodiment, the graphic display 110 is a drawing. Some drawings of the graphic display 110 are drafted by hand on a medium to be placed near the household item 100. Other drawings are generated electronically through computer software that allows a designer to create a graphic display 110 that is later printed and placed in the vicinity of the household item 100. In some instances, analog pictures, such as pictures taken with a film camera, may be converted to digital files that are later printed onto various media that serve as the graphic display 110.

The graphic display 110 of the household item in its intended setting is printed onto a medium for display in the vicinity of the household item 100. The medium may be selected from different types of media. Such media include plain paper, photo paper, glossy paper, canvas, and any other type of media that provides a desirable image in the graphic display 110. The graphic display 110 is printed, or rendered, in various sizes depending on the intended location of the display, the size of the household item 100, and the space available on the showroom floor.

The graphic display 110 may be printed onto the media using various methods known to a person of ordinary skill in the art. In one preferred embodiment of the invention, the graphic display 110 is printed onto the media (paper, canvas, or any other media as described above) utilizing the well-known Giclée method, which is a very fine inkjet printing method producing a continuous tone and identically reproducing the original work. In a particularly preferred embodiment, the graphic display 110 is printed on canvas utilizing the Giclée method to further enhance its aesthetic appeal and increase the likelihood of garnering attention from a shopper. This method results in a high resolution graphic display 110 for use in the method described above. In a particularly preferred embodiment, in order to visually enhance graphic display 110 so as to increase the likelihood of drawing a shopper's attention, the graphic display 110 printed on canvas using the Giclée method may be further embellished so as to create an unusual and eye-catching appearance. For instance, an artist may create an embellished graphic display 110 by applying a translucent coating, such as clear acrylic varnish, with a paint brush or similar device so as to cause the graphic display 110 to have the appearance and touch of an oil painting. By providing such an embellished graphic display 110, the retailer increases the likelihood that a shopper's attention will be captured, and thus that the combined advertising presentation of the actual, full size furniture item and the embellished graphic display 110 showing such furniture item in an intended use environment will be simultaneously viewed by the shopper, creating a first impression that immediately conveys the suitability of the furniture item in a real world, actual use setting.

Given the resulting unique appearance of graphic display 110 resulting from such embellishment, a retail establishment may find additional opportunity to supplement the revenue generated through sale of furniture items by likewise offering such embellished graphic displays 110 for sale. To assist in marketing the graphic displays 110 themselves, the retailer may optionally place a tag or other insignia on the graphic display 110 providing information about the graphic display 110, such as the name of the artist that generated graphic display 110, and the price at which such graphic display 110 is offered for sale. Moreover, in the event that the retailer wishes to provide an option for shoppers to purchase graphic displays 110, as they are presented in a two-dimensional format, a single mounting may contain two graphic displays 110, one on each face of the two-dimensional display, and preferably comprising different pictures.

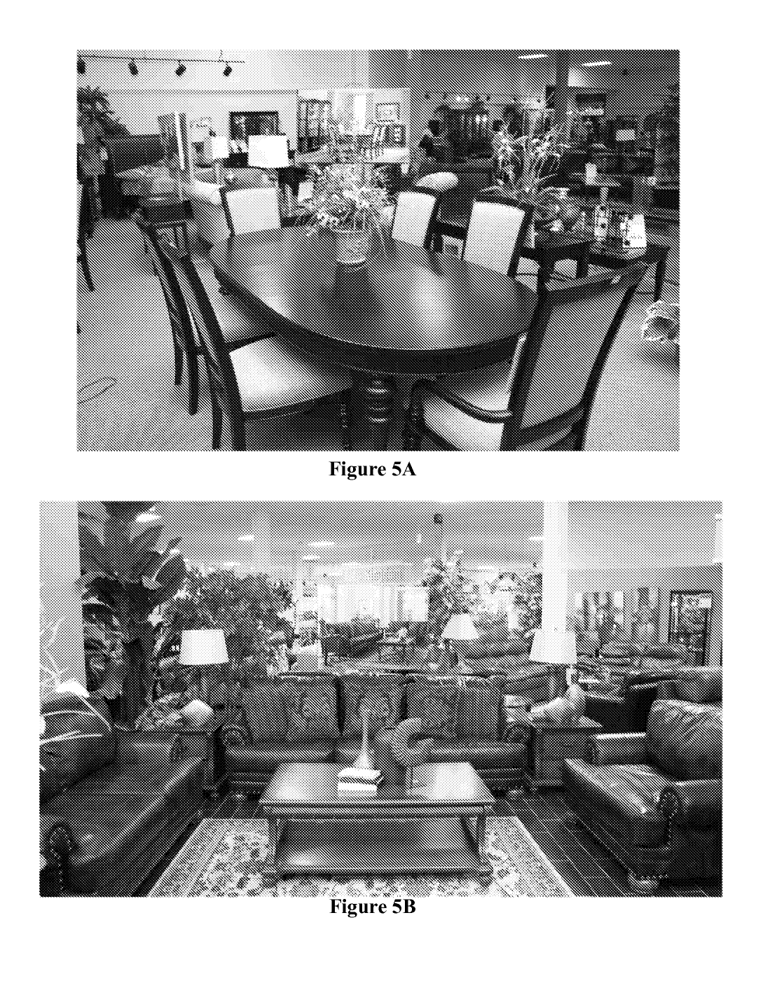

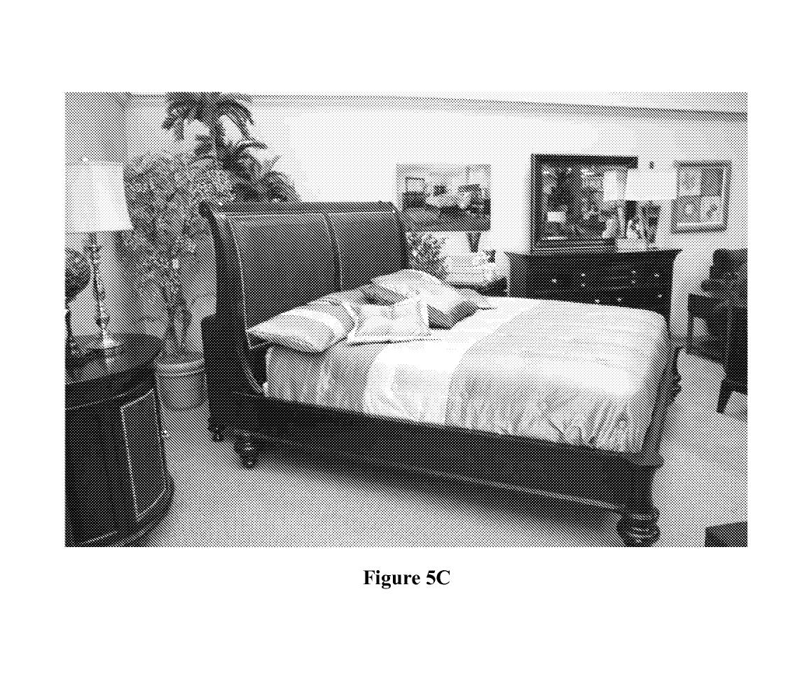

Once the image is printed onto the media, the graphic display 110 is prepared for placement in the vicinity of the household item 100. In a particularly preferred embodiment, the placement of graphic display 110 with respect to the full size furniture item may also be used to increase the likelihood that a shopper's attention will be captured. Particularly, and as shown in FIGS. 5A-C, graphic display 110 may be positioned vertically above the actual furniture item being advertised so as to more quickly draw the shopper's attention, and thus increase the impression in the shopper's mind of the suitability of such furniture item for use in a household or office setting, and particularly the shopper's own intended use setting. Such vertical marketing display further increases the likelihood that the shopper will complete a purchase of the furniture item. Optionally, more than one graphic display 110 may be so positioned with respect to the full size furniture item. In the event that multiple graphic displays 100 are to be used in an advertising display, each graphic display 100 may optionally show a different view of the intended use setting for the furniture item. Each such graphic display 100 may also be of a different size.

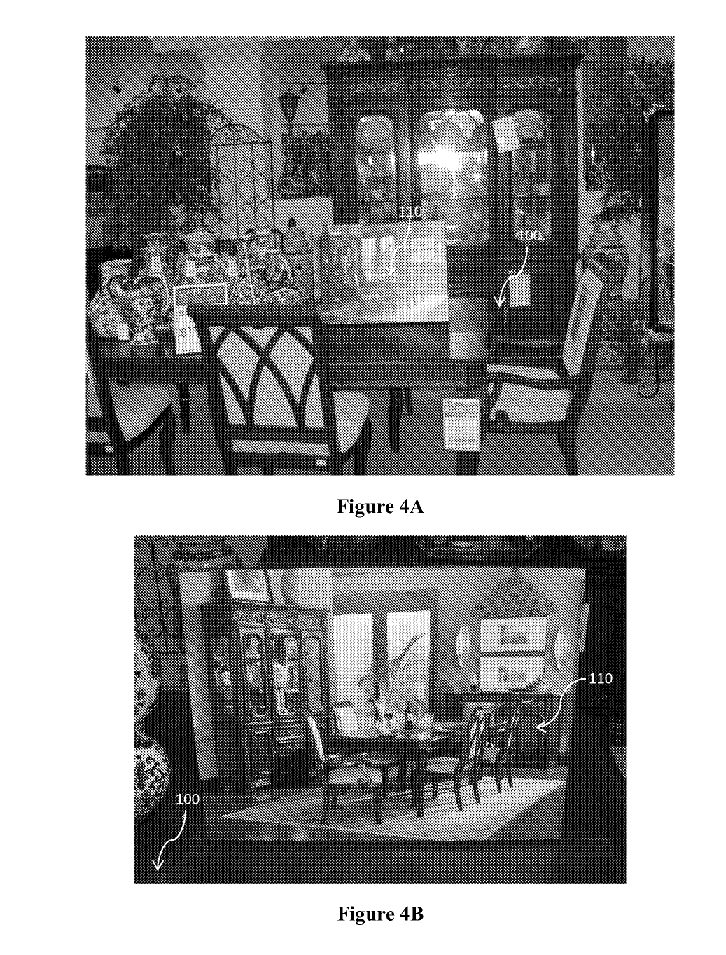

To even further enhance the appearance of graphic display 110 to increase the likelihood that a shopper's attention will be captured, graphic display 110 may be suspended above the full size furniture item using a minimally visible support, thus causing graphic display 110 to have the appearance of a floating image above the full size furniture item. In order to provide such a floating appearance, suspension cables may hang the graphic display 110 from a ceiling above the full size furniture item, which suspension cables should be clear or of a color matching the surroundings, or be sufficiently thin so that they are difficult for a shopper to see when first encountering the advertising display. Alternatively, a pole or easel (as shown in FIGS. 5A-5B) may be positioned on the showroom floor adjacent the full size furniture item and supporting graphic display 110 above the full size furniture item. In this case, the pole or easel should be clear or of a color or other configuration generally matching or blending with the surroundings, or be sufficiently thin so that it is difficult for a shopper to see when first encountering the advertising display. As yet another alternative, a display support may be positioned on the full size furniture item itself (as in FIGS. 4A-4B) that again positions graphic display 110 above the full size furniture item. In this case, the display support should be clear or of a color or other configuration generally matching or blending with the surroundings (e.g., of a color matching the furniture item), or having a sufficiently thin profile so that it is difficult for a shopper to see when first encountering the advertising display.

In each case, it is particularly preferable to ensure that the two dimensional graphic display 110 does not obstruct the browsing customer's view of the full size furniture item 100 being advertised for sale. This ensures that such customer maintains the ability to fully inspect and interact with furniture item 100, and likewise forms an immediate and first combined visual impression of both the actual, full size furniture item 100 and a real world use of such furniture item 100.

As an alternative to suspending graphic display 110 directly over the full size furniture item, graphic display 110 may be hung on a wall behind the furniture item 100, as shown in FIG. 5C. In this case, in order to maintain the floating image appearance described above, the graphic display 110 may be prepared as an “artist wrap.” An “artist wrap” is a method of preparing the graphic display 110 by mounting it on a wooden frame and wrapping the edges of the graphic display 110 around the frame.

In another example, the graphic display 110 may be placed on a picture frame having a border. In a further example, a transparent material may be placed in front of the graphic display 110, which transparent material may be glass or plastic or any other material that allows a person to see the graphic display 110. In yet a further example, the graphic display 110 may be placed on a poster board or other type of board that allows the graphic display 110 to be mounted on a tripod or other display apparatus or device.

It is expected that any type of framing material can be used in association with the graphic display 110. The framing material can be plastic, metal, wood, or any other type of material that provides a rigid frame for the display. When utilizing wood, any type of wood may be used as recognized by a person of ordinary skill in the art. In one preferred embodiment, thermal pressed wood is utilized for framing the graphic display 110. In a further preferred embodiment, the type of wood utilized meets the standards required for export or import of wood into various countries.

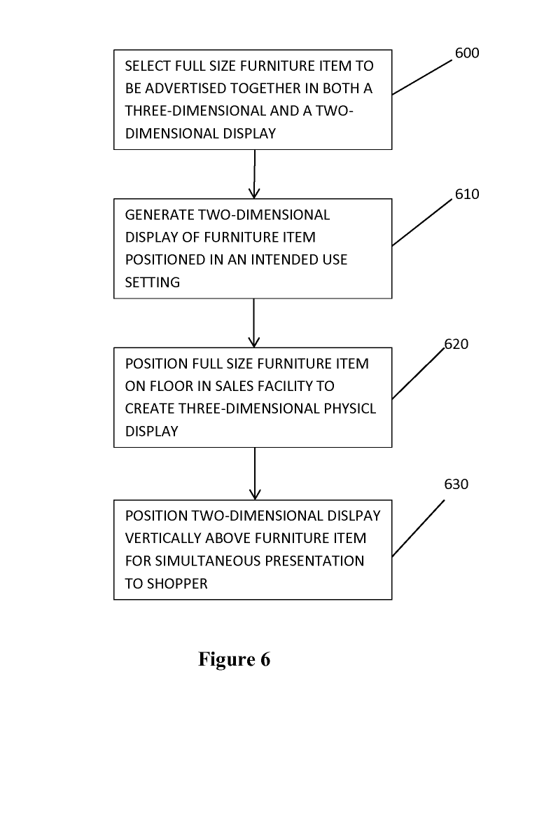

A preferred embodiment of the present invention presents a method for advertising household items 100 as shown in the flowchart of FIG. 6. At step 600, a full size furniture item is selected for advertising in both a three-dimensional, physical display of the entire, full size furniture item in a retail establishment, and simultaneously in a two-dimensional representation of the furniture item in an intended use setting. At step 610, a two-dimensional display is generated of the furniture item positioned in an intended use setting, preferably by printing such display on canvas using the Giclée method, and even more preferably by using the embellishment method described above. That intended use setting provides a perspective view showing the furniture item in an actual room in a residence or office setting in which the furniture item would typically be used. Those skilled in the art will recognize that the furniture item need not be positioned and photographed in an actual enclosed room, so long as the view in the two-dimensional display provides a perspective view of the furniture item placed in what appears to be an actual enclosed room (i.e., a room having walls, a floor, and a ceiling). At step 620, the full size furniture item is positioned on a floor in a sales facility so as to create a three-dimensional, physical display of the entire, full size furniture item. At step 630, the two-dimensional display is positioned vertically above the furniture item in an orientation that will cause a shopper in the retail establishment that is viewing the three-dimensional display to simultaneously view the two-dimensional display. That simultaneous display of both the two-dimensional and three-dimensional displays creates a combined visual impression, and preferably a combined, visual, first impression in the mind of the shopper, of both the full size furniture item and a real world use of the furniture item within a room in a residential or office building, thus enhancing the shopper's overall experience and confidence in making the buying decision.

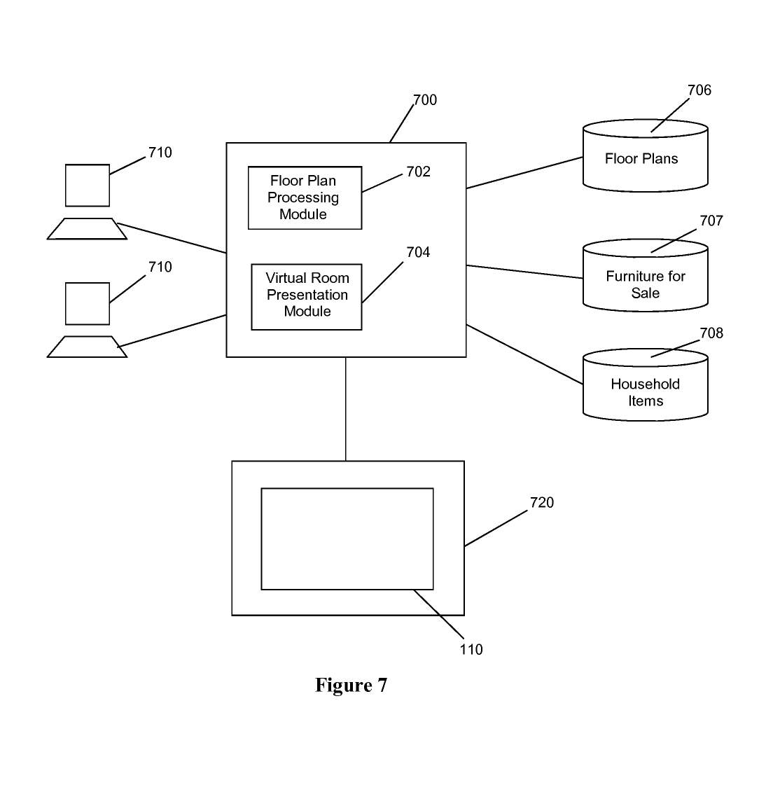

In a further embodiment of the invention, graphic display 110 may be generated by a computer monitor. In this case, a furniture display processing computer may be provided as shown in FIG. 7. Furniture display processing computer 700 may comprise a floor plan processing module 702 and a virtual room presentation module 704, and is preferably in data communication with one or more user terminals 710 that may be used, by way of nonlimiting example, to allow a salesperson or shopper to engage furniture display processing computer 700 as described here. Those of ordinary skill in the art will recognize that such figure is a schematic, exemplary view of the most basic features of such a system, and that additional elements and modifications of such system (e.g., computer bus, processor, memory, etc.) will be necessary in order to fully implement such system.

Furniture display processing computer 700 is preferably also in data communication with display device 720 that receives video or graphic data from furniture display processing computer 700 to display graphic display 110 thereon, as further described below.

Floor plan processing module 702 is configured to receive instructions from user terminals 710, or from a touch screen interface on display device 720, to create or display an electronic version of a floor plan, which floor plan may ultimately be rendered in graphic display 110. For instance, floor plan processing module 702 may provide computer aided design (“CAD”) software that allows a user to create and manipulate an electronic version of an actual room in which they would intend to use furniture item 100. Alternatively, an electronic library 706 of floor plans may be provided from which a user may select a floor plan to be presented in graphic display 110. In one embodiment, library 706 may include floor plans of apartment or housing complexes within a predetermined geographic distance of the retail store from which the furniture item 100 is being offered for sale, thus allowing the user to recall floor plans that are likely suitable for customers within such retail store, even where the customers do not know the particular dimensions of the intended use space for the furniture item.

Additionally, an electronic digital image library 707 may be provided in data communication with furniture display processing computer 700, which digital image library 707 includes digital images of furniture items for sale at the retail store. Digital images or other electronic representations of furniture items for sale can be selected from library 707 and variably positioned in the virtual floor plan. After selection and placement of such digital image of the furniture item is accomplished, virtual room presentation module 704 may process the floor plan and image data to render an electronic image of the room intended for use of the furniture item 100.

Optionally, an additional digital image library 708 of other household items and accessories 130 may also be provided, which digital images of household items and accessories may be included in the virtual room setting generated by virtual room presentation module 704 to present a graphical display 110 of a completely furnished room.

In an embodiment of the invention, display device 720 is placed in the vicinity of household item 100 as described above. It is contemplated that display device 720 may be a regular computer screen or any other type of screen that allows the display of the household item 100 in the environment in which it is expected to be used.

In one preferred embodiment of the invention, access to electronic library 706 of floor plans may be provided through display device 720. Each of libraries 706, 707, and 708 may be stored in the computer 700 or accessible through a network, such as the internet. A person of ordinary skill in the art would understand that access to such libraries may be accomplished in many different ways, and that the resulting graphic display 110 may be displayed on the display device 720 in a variety of ways. In addition to those elements shown in FIG. 7, a processor, a server, internet access, a keyboard, and other devices that allow access to and use of furniture display processing computer 700 and libraries 706, 707, and 708 may be provided without departing from the spirit and scope of the invention.

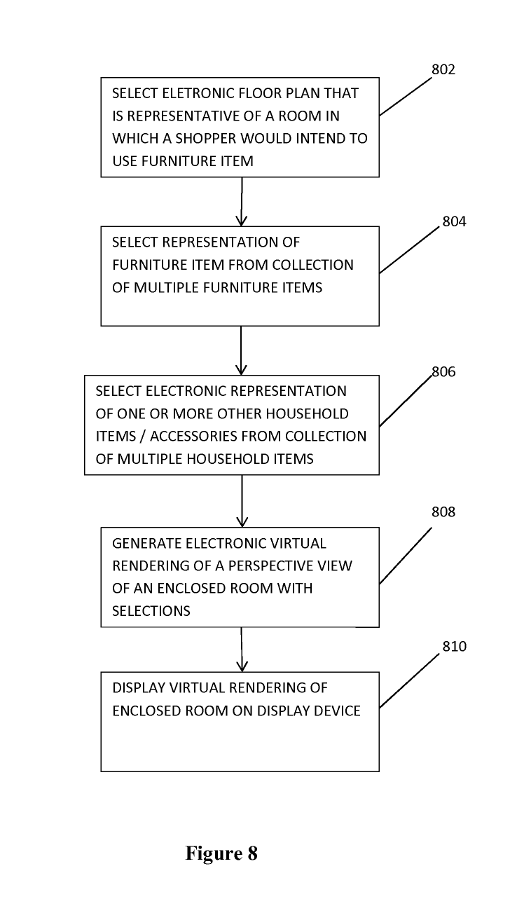

FIG. 8 shows an exemplary method for use in the computing system of FIG. 7. At a first step 802, an electronic floor plan is selected that is representative of a room in which a shopper would intend to use the furniture item. As explained above, such electronic floor plan may be customized per the shopper's specifications, or may alternatively be selected from floor plan library 706. At step 804, an electronic representation of a furniture item is selected from a collection of multiple furniture items available for sale at the retail store. At step 806, an electronic representation of one or more other household items or accessories is selected from a collection of multiple household items and accessories. At step 808, an electronic virtual rendering of a perspective view of an enclosed room is generated, which virtual rendering includes the selected furniture item and selected additional household items and accessories appearing positioned in such enclosed room. Finally, at step 810, the virtual rendering is displayed on display device 720.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

What is claimed is:

1. A method for advertising a standalone, full size furniture item comprising the steps of:
selecting a full size furniture item to be advertised in both a three-dimensional, physical display of the entire, full size furniture item in a retail establishment and in a two-dimensional representation of said furniture item in an intended use setting;
generating at least one two-dimensional display of said furniture item positioned in an intended use setting, said two-dimensional representation further comprising a first perspective view appearing to show said furniture item in an actual room in a residence or office setting in which said furniture item would typically be used;
positioning said full size furniture item in standalone form on a floor in a sales facility so as to create a three-dimensional, physical display of the entire, full size furniture item; and
positioning said at least one two-dimensional display of said furniture item vertically above said furniture item in an orientation that will cause a shopper in said retail establishment that is viewing said three-dimensional display of said furniture item to simultaneously view said two-dimensional display of said furniture item, and that creates a combined visual impression of both of said full size furniture item and a real-world use of said furniture item within a room in a residential or office building.

2. The method of claim 1, wherein said at least one two-dimensional display is mounted above said furniture item so as to create the appearance of a floating image above said furniture item.

3. The method of claim 2, wherein said at least one two-dimensional display is held above said furniture item using a minimally visible suspension device.

4. The method of claim 3, wherein said minimally visible suspension device comprises cables hanging said two-dimensional display from a structure above said furniture item.

5. The method of claim 3, wherein said minimally visible suspension device comprises a pole positioned on said floor adjacent said furniture item.

6. The method of claim 3, wherein said minimally visible suspension device comprises an easel positioned on said floor adjacent said furniture item.

7. The method of claim 3, wherein said minimally visible suspension device comprises a display support positioned on said furniture item.

8. The method of claim 2, wherein said at least one two-dimensional display is presented on an artist wrap mounted on a wall panel adjacent said furniture item so that said two-dimensional display appears in a plane in front of said wall panel.

9. The method of claim 1, wherein said at least one two-dimensional representation further comprises an image printed using the Giclée method.

10. The method of claim 9, further comprising brush-applying a translucent coating to said image so as to cause said at least one two-dimensional representation to have the appearance and touch of an oil painting.

11. The method of claim 1, further comprising:
generating a second two-dimensional display of said furniture item positioned in said intended use setting and comprising a second perspective view of said furniture item that is different from said first perspective view; and
positioning said second two-dimensional display vertically above said furniture item.

12. The method of claim 1, said at least one two-dimensional display including additional items that are thematically associated with said intended use setting.

13. The method of claim 1, wherein said at least one two-dimensional display further comprises an electronic video display showing an electronic virtual rendering of said first perspective view.

14. The method of claim 13, further comprising:
providing a furniture display processing computer in data communication with said at least one two-dimensional display;
receiving at said furniture display processing computer an electronic floorplan representative of a room to be used as said intended use setting;
receiving at said furniture display processing computer a selection of a furniture item from a collection of multiple furniture items, whereby the selected furniture item is an electronic representation of said full size furniture item;
generating said electronic virtual rendering of said first perspective view that includes said selected furniture item within said electronic floor plan; and
displaying said electronic virtual rendering on said two-dimensional display.

15. The method of claim 14, wherein said electronic floor plan is selected from an electronic library of multiple floor plans.

16. The method of claim 15, wherein said electronic library of multiple floor plans further comprises electronic floor plans of rooms in properties that are located within a predesignated geographical distance from said sales facility.

17. The method of claim 14, wherein said electronic floor plan is customized to user-designated dimensions.

18. The method of claim 14, further comprising:
receiving at said furniture display processing computer a selection of one or more other household items from an electronic collection of other household items, wherein said perspective view generated in said generating step includes the selected one or more other household items.
